(19) United States
(12) Patent Application Publication
(10) Pub. No.: US 2004/0190564 A1
(43) Pub. Date: Sep. 30, 2004

(54) Hybrid Q-switch device, lasers using the same, and method of operation

(75) Inventor: Wang Long Zhou, Reading, MA (US)

Correspondence Address: SCULLY SCOTT MURPHY & PRESSER, PC, 400 GARDEN CITY PLAZA, GARDEN CITY, NY, 11530

(73) Assignee: LAMBDA SOLUTIONS, INC., POUND RIDGE, NY

(21) Appl. No.: 10/766,706

(22) Filed: Jan. 27, 2004

Related U.S. Application Data
(60) Provisional application No. 60/443,424, filed on Jan. 29, 2003.

(51) Int. Cl. H01S 3/11

(52) U.S. Cl. 372/10

(57) ABSTRACT

A hybrid Q-switch device for a laser device having a laser medium being pumped with energy includes a solid-state saturable absorber element for controlling loss modulation of the laser medium; an active Q-switch element having open and closed states for controlling loss modulation of the laser medium and positioned in series with the laser medium and the absorber element; and, a device for adjusting timing of the open and closed states of the active Q-switch element. The combined loss modulation control from active Q-switch and absorber elements enable generation of a short width, high peak power pulse at a lasing wavelength. Particularly, the loss modulation effects of active and passive Q-switch means are timed to minimize cavity loss at which time a high peak power pulse of small pulse width is generated.

### CROSS REFERENCE TO RELATED APPLICATION

This application claims the benefit of U.S. Provisional Patent Application Serial No. 60/443,424 filed Jan. 29, 2003.

### BACKGROUND OF THE INVENTION

1. Field of the Invention

The present invention relates generally to laser devices, and more particularly, Q-switches and methods of Q-switching for pumped laser systems.

2. Discussion of the Prior Art

Many laser applications, such as remote sensing, radar, and laser-induced breakdown spectroscopy (LIBS), demand high peak laser power. In general, for a certain pulse energy, the shorter the duration of the pulse, the higher the peak power. Although ultra-short (<100 ps, 1 ps=10⁻¹²s) laser pulses can be generated through complicated mode-lock method, the energy per pulse is normally very low due to intrinsically high pulse repetition rate (>MHz). For high energy and peak power pulses, Q-switching is the most-often the choice because its repetition rate could be under several hertz.

There are many different Q-switch methods and they are generally divided into two categories, i.e., “active” and “passive”. Active Q-switch is controllable on pulse reproduction but bulky and expensive, while passive Q-switch is small and inexpensive, but lack control.

The most widely used active Q-switches are electro-optic (EO) and acoustic-optic (AO) Q-switches. They require complicated electronic control circuits and bulky EO or AO crystals (e.g., about 20˜30 mm in length). The advantages of an active Q-switch are the free control of pulse repetition rate and the high pulse reproducibility (low time jitter and high pulse-to-pulse stability). The pulse duration is largely dependent on the rise-time of the electronic control signal and the corresponding response of the EO or AO crystal. EO Q-switches are able to generate sub-10 ns (nanosecond=10⁻⁹s) pulses while AO Q-switch normally delivers sub-100 ns pulses.

Rotating a cavity mirror or a chopper is also an active way to Q-switch a laser. It is relatively simple and has been utilized in early embodiments of laser devices. The advantage of this method is simplicity and lossless when the Q-switch is totally opened or aligned. However, it has been revealed that a laser Q-switched with only a rotating element is not able to produce short-duration high-peak-power pulse due to slow evolution from edge cut to entire open. As the laser pulse is actually formed before the entire open, it suffers high loss. Use of a rotating element is now virtually obsolete due to the difficulty of obtaining short-duration and high-peak pulse with this method.

Passive Q-switches only need a saturable absorber that is placed inside the laser cavity. The absorber prevents the laser from lasing by greatly absorbing energy at the lasing wavelength until it is saturated. Once saturated, the absorber suddenly becomes transparent to the lasing wavelength so that the energy stored in the laser medium is triggered to release in a short period to form a short laser pulse. The absorber will then recover to its initial state and be ready for the next cycle. A microchip Nd:YAG laser with Cr⁴⁺:YAG absorber has been demonstrated to generate pulses shorter than 300 ps as described in U.S. Pat. No. 5,394,413.

Passive Q-switches are simple and are able to generate sub-ns or even shorter pulses. However, the timing of the onset of the absorber becoming transparent fluctuates upon inevitable variations of pumping power, pumping wavelength, temperature, and other cavity related parameters. The pulse repetition rate changes along with pumping power and is also dependent on various parameters of laser medium, absorber, and cavity geometry. Therefore, a laser with a passive Q-switch lacks pulse generation control in terms of repetition rate and pulse-to-pulse time jitter and energy stability. Furthermore, under continuous-wave pumping, the repetition rate of a passive Q-switch laser is typically too high for getting highest peak power. Additionally, a laser with a passive Q-switch must operate near the threshold in order to prevent the occurrence of sub-pulses, which greatly limits the laser output.

The disadvantages of a passive Q-switch could be largely eliminated by an active Q-switch, and vise versa. Thus, to some degree, active and passive Q-switches may be considered characteristically complimentary.

It would thus be highly desirable to provide a laser device that implements both active and passive Q-switching in a manner so as to obtain the benefits of both embodiments while minimizing the-disadvantages of each.

It would further be highly desirable to provide an innovative hybrid Q-switch that combines both active and passive system physically and characteristically for laser devices requiring high-peak pulse power.

### SUMMARY OF THE INVENTION

According to one aspect of the present invention, there is provided a hybrid Q-switch device for a microchip laser device. The hybrid Q-switch comprises active and passive means of loss modulation, whereby Q-switch cycles from closing (maximum loss) to opening (minimum loss). Active Q-switches may be of the type that do not have moving parts and employ means such as an electric field or an acoustic wave to actively modulate the cavity loss. The passive means of loss modulation is implemented by a saturable absorber that absorbs light (high loss) until becoming saturated (low loss). The active and passive means are, respectively, an active element, such as state-of-art EO and AO Q-switches, or a rotating chopper, etc., and a solid state saturable absorber, such as Cr⁴⁺:YAG.

Another aspect of the present invention is to provide a microchip laser for generating repetition-rate-controllable pulse with pulse widths ranging from about 50.0 ps to 10.0 ns. According to this aspect of the present invention, the microchip laser comprises two mirrors forming a resonant cavity, a solid-state laser medium, such as Nd:YAG, Yb:YAG, and Nd:YVO₄, and a chopper/absorber hybrid Q-switch.

Advantageously, the hybrid Q-switch laser of the invention emits pulses, which are well regulated and of high energy per pulse as from a conventional active Q-switch laser and have short duration as from a conventional passive Q-switch laser. Due to shorter pulse duration and combined cavity loss modulation, as will be explained hereinafter, the hybrid Q-switch laser consumes less power and implements simpler electronics to generate pulses of certain peak power than a corresponding active Q-switch laser.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts a conventional laser with an active Q-switch;

FIG. 2 depicts a conventional laser with a passive Q-switch (saturable absorber);

FIG. 3 depicts a laser device with a hybrid Q-switch according to the present invention; and,

FIG. 4(a) depicts a microchip laser device with a chopper/absorber hybrid Q-switch according to the present invention and FIG. 4(b) depicts a rotary chopper blade having a number of openings (slits).

### DETAILED DESCRIPTION OF THE PREFERRED EMBODIMENTS

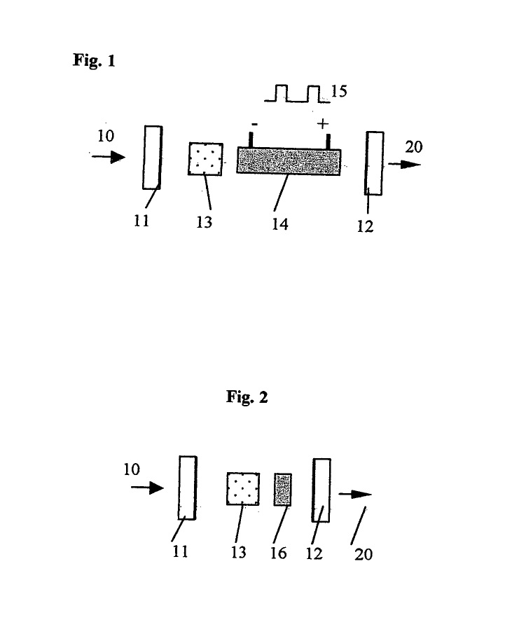

FIG. 1 shows a typical active Q-switch laser comprising a laser medium 13 for providing optical gain, and an active Q-switch 14 and two mirrors 11 and 12 at the ends of an enclosed cavity to enhance stimulated emission. Although not shown in FIG. 1, the laser medium is end-pumped with an energy pump source 10 which may comprise a semiconductor laser, a solid-state laser, or a gas laser. If pumped with flash lamp, then the laser cavity and the laser medium would normally be designed for side pumping.

The active Q-switch 14 could be an acoustic-optic (AO) Q-switch that utilizes a bulk AO crystal, such as quartz and TeO2, and it requires a high-power radio frequency source to generate acoustic wave propagating through the crystal to diffract out lasing wavelength. Lasers with AO Q-switch can emit sub-50 ns pulses. For sub-10 ns pulses, electro-optic (EO) Q-switch would be more often being employed. In an EO Q-switch, an EO crystal, such as KDP, BBO, and LiNbO₃, would be used. The cavity loss modulation is realized by changing the crystal's birefringent characteristic through applying kilovolt electric pulses on the crystal. The crystal could be several centimeters long for lowering high voltage requirement.

For explanation purpose, it is assumed that an EO Q-switch is adopted in the laser of FIG. 1. The EO Q-switch 14 is driven by high-voltage electric pulse 15 through +/− electrodes. A laser pulse 20 is generated from the laser at the lasing wavelength. The pulse repetition rate can be precisely defined by adjusting the frequency of the electric pulse. The duration of the laser pulse is largely dependent on the rise time (˜several ns) of the electric pulse. An EO or AO Q-switch is able to produce stable and well-defined pulses. However, it is bulky and costly and needs complicated electronics, and is not suitable for obtaining pulses shorter than several nano-seconds.

In the past decade, passive Q-switches have been extensively studied and already applied in the commercial laser products. It uses a saturable absorber, such as Cr⁴⁺:YAG, to absorb the intended lasing wavelength to prevent lasing for a period and then the absorber gets saturated and suddenly becomes transparent to enable the lasing. The absorber will recover to the unsaturated state before the laser medium is pumped to an extent sufficient for another lasing.

Passive Q-switch is simple, compact, and low lost, and does not require electronic power supply. FIG. 2 shows a typical passive Q-switch laser with a saturable absorber 16. The absorber 16 is a solid-state material that is absorption-saturable to the intended lasing wavelength. It includes Cr⁴⁺:YAG, Cr-doped forsterite, Cr-doped gadolinium scandium gallium garnet, saturable semiconductor material, and semiconductor-doped glass, etc. For example, the saturable absorption for Cr⁴⁺:YAG is ranging from 900 nm to 1200 nm.

Studies have revealed that passive Q-switch could be used to produce pulses in the pico-second (ps) regime. Zayhowski (U.S. Pat. No. 5,394,413) has demonstrated a Nd:YAG/Cr⁴⁺:YAG microchip laser with <300 ps pulse output. A Nd:YVO₄ microchip laser with 56 ps pulse output is reported by Braun et al (Opt. Lett., v22 p381, 1997), where a semiconductor anti-resonant Fabry-Perot saturable absorber is utilized.

Although a passive Q-switch could generate sub-ns pulse, the energy per pulse is very limited (typically under 10 uJ) due to intrinsically high repetition rate and near threshold pumping. Near threshold pumping is required for preventing the occurrence of sub-pulses. Compared to active Q-switch, pulses from passive Q-switch normally have larger time jitter and peak-to-peak power fluctuation, because the timing of the onset of the absorber becoming transparent fluctuates upon the variations of pumping power, pumping wavelength, temperature, and other parameters. This latter problem is addressed by the present invention by coupling the triggering of the passive switch to an active Q-switch.

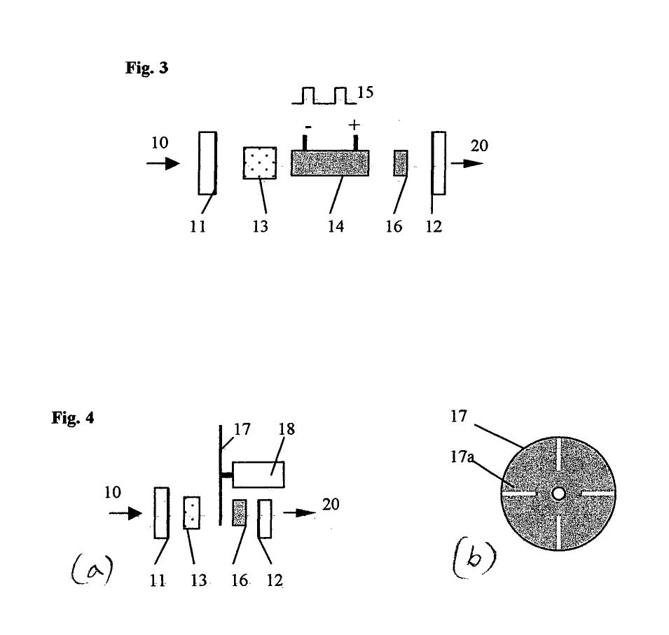

That is, according to the present invention, a hybrid Q-switch is provided that comprises means of both active and passive loss modulations. FIG. 3 is a laser embodied with a hybrid Q-switch of the invention comprising an active Q-switch 14 and a saturable absorber element 16 (passive switch). In one embodiment, as shown in FIG. 3, the absorber element 16 is located in the cavity to the emission (right) side of the active Q-switch 14 as shown in the figure. It may also be positioned at the left side or even bonded together with the active Q-switch crystal.

The sequence of laser function is as follows: The laser medium 13 is continuously pumped by pumping source 10, e.g., an optical pumping source, such as another laser energy from a laser diode. During this pumping time, the active switch is closed (the passive switch is also in the closed state because there is no light to saturate the absorber) and cavity loss is maximized such that the laser medium absorbs energy thereby effectively increasing the gain of the device to a certain or even gain-saturated level. Then, the active Q-switch 14 is opened (i.e., active Q-switch induced cavity loss is reduced to a minimum) when an electric pulse 15 comes (or, as will be explained hereinbelow, when the slit of a rotary chopper is aligned with the lasing medium). At that time the laser will then commence lasing at noise level at the intended lasing wavelength, which will be partially absorbed by the absorber 16 and will eventually cause the absorber to become saturated (i.e., passive absorber induced cavity loss is reduced to a minimum). As a result, the total cavity loss drops dramatically and the laser starts oscillation above noise level and forms the front part of a pulse. The pulse grows and then drops quickly as it consumes all or most of the gain stored in the laser medium within a short duration. Then the lasing will discontinue and the absorber 16 will recover to its initial state (i.e., the passive switch closes again). Subsequently, the active Q-switch will become closed again to complete a full pulsing cycle. It should be understood that the active switch may be closed before the absorber fully recovers to its initial state. The time window of the active Q-switch being opened equals the duration of the electric pulse 15 and should be narrow enough to avoid sub-pulsing (i.e., not more than one pulse within one opening window).

There is a time interval between the opening of the active Q-switch and the onset of saturation of the absorber. The laser will fire a pulse only when or after the absorber is saturated. Therefore, the absorber also acts as a time-delayer of pulsing. Once the active switch is entirely opened, the cavity loss modulation is only depended on the passive absorber and thereby the duration of the laser pulse is determined by the passive absorber and other cavity parameters, but not the active Q-switch. On the other hand, because the opening of the active Q-switch happens after the laser medium has been pumped to a certain or even saturated gain level, this time interval, i.e., the time of pulsing, will be much more regulated than the timing of the saturation onset of a free-running conventional passive Q-switch laser.

Thus, as a result, a laser with such hybrid Q-switch could produce sub-ns or even shorter pulses due to pulse characteristic of a passive laser and having the high reproducibility as those from an active laser. The pulse repetition rate will be controllable and can be adjusted to a value for the highest peak power or the maximum efficiency. Additionally, by adjusting the opening time window of the active Q-switch, the laser will work well above the lasing threshold without the occurrence of a sub-pulse so that pulses with much higher energy could be generated than a conventional passive laser. Compared to a laser with a normal active Q-switch, the laser of the present invention could generate pulses of shorter duration and higher peak power with same pumping energy, or generates same peak-power pulses with less pumping energy. Obviously, the hybrid Q-switch of the present invention combines the advantages of both active and passive Q-switches and eliminates their drawbacks.

In addition, the hybrid Q-switch is not mechanically more complicated than the corresponding active Q-switch. In fact, due to the addition of passive loss modulation, the depth of active loss modulation could be reduced so that a shorter EO/AO crystal or lower-voltage electronics can be used. Those electronics could be further simplified because of a relaxed requirement of short rise-time for the active switch due to the time delay of pulsing induced by the passive absorber. As a consequence, a laser device implementing the hybrid Q-switch of the invention could be more compact and less expensive than one implementing a corresponding active Q-switch, and further, could generate higher peak-power pulses at the same pumping condition (because of shorter pulse duration).

Nevertheless, compared to a passive one, a hybrid Q-switch based on an EO or AO active Q-switch may be still bulky and expensive. In another embodiment, a hybrid Q-switch according to the present invention is provided that comprises the combination of a fast rotating chopper and a saturable absorber. A rotating chopper is simple and the corresponding power consumption is negligible. The chopper could be very thin (<0.5 mm) so that a laser with such a hybrid Q-switch will be as compact as one with only a saturable absorber. A motor that drives the chopper may easily achieve over 250 turns per second. Adding more opening holes/slits on the chopper can increase the repetition rate.

As mentioned early, a laser Q-switched by a rotating element only is not able to produce short-duration high-peak-power pulse due to slow evolution from edge cut to entire open. As the laser pulse is actually formed before entire open, the laser cavity suffers high loss.

However, by combining with a passive absorber, a time delay for forming a pulse is added, i.e., the laser will not lase during the chopper early high-loss opening stage until the absorber is saturated. Therefore, a laser with this hybrid Q-switch suffers much less loss and can produce much shorter and higher-peak pulses than that with chopper-only Q-switch.

FIG. 4(a) shows a microchip laser embodied with a chopper/absorber hybrid Q-switch of the invention. ‘Microchip laser’ is a term means that the laser medium is thin (<couple mm) and is typically diode-pumped and the laser has a short cavity and so is extremely compact. For further compactness, the pump-side face of the laser medium 13 is coated for high reflection at the lasing wavelength and so it serves as one cavity mirror 11. Likewise, the output-side face of the absorber 16 at the further end is coated for high reflection at the lasing wavelength to serve as the other mirror 12 of the output side of the resonator cavity as shown in FIG. 4(a). In another embodiment, the absorber 16 is placed adjacent to the laser medium 13 and they may even be bonded together. In another embodiment, a single YAG crystal co-doped with Nd³⁺ and Cr⁴⁺ is used that acts as both laser-gain medium and saturable absorber. All the alternatives mentioned here are also applicable to the embodiment of the invention shown and described with respect to FIG. 3.

Referring back to FIG. 4(a), the chopper 17 is driven by a micromotor 18. The diameter of the chopper is under 12 cm, and preferably, between 1.5˜4.0 cm for a microchip laser device. There will be at least one opening hole or slit on the chopper to regulate pulse generation (active-Q-switch gate opening). As shown in FIG. 4(b), an example of a chopper 17 with four opening slits 17a is depicted. The width of each slit should be larger than the resulting laser beam diameter, and preferably, about twice the width of the laser beam diameter. Preferably, the width of each slit is narrow enough for avoiding sub-pulsing. In another embodiment, the width of the slits are adjustable. For example, two identical choppers with slits may be implemented with the crossover of two sets of slits adjusted to get a final required opening. They may thereafter be rotated together in fixed relation after being adjusted to have a proper crossover. Basically, the faster the evolution from edge cut to entire open, the better. Therefore, it is favorable to use a chopper of diameter as large as possible. In a high power laser that is usually of larger dimensions, a chopper with diameter larger than 12 cm might be implemented.

Lasers equipped with the hybrid Q-switch of the present invention find wide applications in fields requiring short pulses with high peak power. Some applications include, but are not limited to: LIBS, Laser induced fluorescence, Remote Sensing; Radar, Laser cleaning, Laser deposition, multi-photon absorption, and non-linear optics.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described my invention, what I claim as new, and desire to secure by letters patent is:

1. A laser device having a laser medium in a resonator cavity comprising:
a) means for pumping energy into said laser medium to increase gain of said laser device;
b) active Q-switch means having open and close states for controlling loss modulation of said resonator cavity; and,
c) passive Q-switch means for further controlling loss modulation of said resonator cavity, wherein loss modulation control from active and passive Q-switch means enable generation of a short width, high peak power pulse at a lasing wavelength.

2. The laser device as claimed in claim 1, wherein loss modulation effects of active and passive Q-switch means are timed to minimize cavity loss at which time a high peak power pulse is generated.

3. The laser device as claimed in claim 2, capable of generating high peak power pulse having a width ranging between from about 50 ps to 10 ns.

4. The laser device as claimed in claim 2, wherein when said active Q-switch means is in a closed state, said laser medium absorbs energy to a certain gain level.

5. The laser device as claimed in claim 2, wherein said passive Q-switch means saturates at a time after the active Q-switch enters an open state to enable generation of a high peak power pulse of short duration.

6. The laser device as claimed in claim 2, further comprising means for triggering the active Q-switch means to provide an open time window adjusted to avoid occurrence of sub-pulsing.

7. The laser device as claimed in claim 6, wherein said active Q-switch means comprises an acousto-optical (AO) device for controlling loss modulation at a predetermined pulse repetition frequency.

8. The laser device as claimed in claim 6, wherein said active Q-switch means comprises an electro-optical (EO) crystal for controlling loss modulation at a predetermined frequency.

9. The laser device as claimed in claim 2, wherein said active Q-switch means comprises a rotating chopper device having open slits for controlling loss modulation at a predetermined frequency.

10. The laser device as claimed in claim 2, wherein said laser medium is a solid-state laser material comprising one selected from the group comprising: Nd:YAG, and Nd:YVO₄.

11. The laser device as claimed in claim 2, wherein said passive Q-switch means comprises a solid-state saturable absorber.

12. The laser device as claimed in claim 2, wherein said saturable absorber includes Cr⁴⁺:YAG.

13. The laser device as claimed in claim 11, wherein said solid-state laser material and said solid-state saturable absorber is physically bonded together.

14. The laser device as claimed in claim 10, wherein said solid-state laser material and said solid-state saturable absorber are integrated.

15. The laser device as claimed in claim 14, wherein said integrated solid-state laser material and said solid-state saturable absorber comprise a YAG crystal co-doped with Nd³⁺ and Cr⁴⁺.

16. A hybrid Q-switch for a laser device having a laser medium being pumped with energy comprising:
a solid-state saturable absorber element for controlling loss modulation of said laser device;
an active Q-switch element having open and closed states for controlling loss modulation of said laser device and positioned in series with said laser medium and said absorber element; and,
means for adjusting timing of said open and closed states of the active Q-switch element, wherein combined loss modulation control from active Q-switch and saturable absorber elements enable generation of a short width, high peak power pulse at a lasing wavelength.

17. The hybrid Q-switch as claimed in claim 16, wherein when said active Q-switch means is in a closed state, said laser medium absorbs energy to a certain gain level.

18. The hybrid Q-switch as claimed in claim 17, wherein said saturable absorber element saturates at a time after the active Q-switch enters an open state to enable generation of a high peak power pulse of short duration.

19. The hybrid Q-switch as claimed in claim 18, wherein an open state of said active Q-switch means is adjusted to avoid occurrence of sub-pulsing.

20. The hybrid Q-switch as claimed in claim 18, wherein said active Q-switch element includes an electro-optical crystal triggered to adjust time of said open and close states.

21. The hybrid Q-switch as claimed in claim 18, wherein said active Q-switch element includes an acousto-optical crystal triggered to adjust said open and close states and thereby control optical gain of said laser medium.

22. The hybrid Q-switch as claimed in claim 18, wherein said active Q-switch element includes a rotating chopper device having one or more slits each of predetermined width for adjusting time of said open and close states.

23. The hybrid Q-switch as claimed in claim 22, wherein a diameter of the chopper is less than about 12.0 cm in diameter.

24. The hybrid Q-switch as claimed in claim 22, wherein a width of each opening slit is larger than a diameter of a laser beam emitted by said laser device.

25. The hybrid Q-switch as claimed in claim 22, further including two overlapped identical choppers each having slits, said choppers having their slits crossover so that a final opening width is changeable by adjusting a degree of mutual crossover.

26. A method of operating a laser device having a laser medium comprising the steps of:
a) pumping the laser medium to increase gain of said laser device;
b) controlling loss modulation of a resonator cavity of said device by active Q-switch means;
c) controlling loss modulation of a resonator cavity by passive Q-switch means,
wherein loss modulation control from active and passive Q-switch means enable generation of a short width, high peak power pulse at a lasing wavelength.

27. The method as claimed in claim 26, further including the step of timing loss modulation effects of active and passive Q-switch means to minimize cavity loss.

28. The method as claimed in claim 26, wherein said controlling loss modulation step b) includes:
closing said active Q-switch means for a time sufficient for said laser medium to absorb energy to a certain gain level.

29. The method as claimed in claim 26, wherein said absorber element saturates at a time after the active Q-switch enters an open state to enable generation of a high peak power pulse of short duration.

30. The method as claimed in claim 26, further comprising the step of: triggering the active Q-switch means to provide an open time window adjusted to avoid occurrence of sub-pulsing.
